(19) United States
(12) Patent Application Publication
(10) Pub. No.: US 2006/0151469 A1
(43) Pub. Date: Jul. 13, 2006

(54) Cooking apparatus

(75) Inventors: Byoung-In Lee, Suwon-si (KR); Dong-won Kim, Suwon-si (KR); Seon-uk Na, Yongin-si (KR); Yong-Hyun Kwon, Suwon-si (KR); Seong-deog Jang, Suwon-si (KR); Chul Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/283,688

(22) Filed: Nov. 22, 2005

(30) Foreign Application Priority Data
Jan. 13, 2005 (KR) 2005-0003312

(51) Int. Cl. H05B 3/68

(52) U.S. Cl. 219/450.1

(57) ABSTRACT

A cooking apparatus having a grill part to cook food thereon, and a grill housing coupled with the grill part, the cooking apparatus includes an electric heater provided in a middle region of the grill housing to be disposed at a lower side of the grill part, and a grill reflecting member reflecting heat generated from the electric heater to the grill part. The cooking apparatus enhances a cooking efficiency so that heat generated from an electric heater is efficiently transmitted to food.

### CROSS-REFERENCE TO RELATED APPLICATIONS

This application claims the benefit of Korean Patent Application No. 2005-0003312, filed on Jan. 13, 2005, in the Korean Intellectual Property Office, the disclosure of which is incorporated herein by reference.

### BACKGROUND OF THE INVENTION

1. Field of the Invention

The present invention relates to a cooking apparatus, and more particularly, to a cooking apparatus enhancing a cooking efficiency so that heat generated from an electric heater is efficiently transmitted to food.

2. Description of the Related Art

Conventionally, “grilling” refers to a method of broiling meats, fishes or shellfishes, etc. on a gridiron or directly roasting skewered meats or fishes on the fire. A grill device as a kind of household electric appliance refers to a device to broil them by using electricity or gas, etc.

Particularly, an electric grill device cooks food by using an electric heater as heating source to generate the heat by the electric power. The electric grill device includes a main body having a grill part directly contacting and cooking food. Heat generated by the electric heater is reflected to the grill part by a grill reflecting member and used when food is cooked.

A conventional grill device disclosed in Korean Patent First Publication No. 2004-39155 includes a main body having a box shape, a plurality of heating members provided inside the main body, for heating food, a grill member disposed in an upper part of the main body, for making food seated thereon, and a heat reflection member disposed in a lower part of the main body, for transmitting a radiant heat of the heating member to the grill member.

In the conventional cooking device, heat generated from the heating members is transmitted to the heat reflection member for cooking food. However, the conventional cooking device has a problem in that the heating members are disposed on side walls of the main body, so that heat also can be transmitted to the side walls of the main body.

Therefore, if heat generated from the heating members is efficiently transmitted to the heat reflection member for cooking food, a cooking efficiency may be enhanced.

### SUMMARY OF THE INVENTION

Accordingly, it is an aspect of the present invention to provide a cooking apparatus to enhance a cooking efficiency so that heat generated from an electric heater is transmitted to food.

Additional aspects and/or advantages of the invention will be set forth in part in the description which follows and, in part, will be apparent from the description, or may be learned by practice of the invention.

The foregoing and/or other aspects of the present invention are achieved by providing a cooking apparatus having a grill part to cook food thereon, and a grill housing coupled with the grill part, the cooking apparatus including an electric heater provided in a middle region of the grill housing to be disposed at a lower side of the grill part, and a grill reflecting member reflecting heat generated from the electric heater to the grill part.

The grill reflecting member includes at least a pair of reflection faces disposed in a direction of emitting the heat from the electric heater, to reflect the heat generated from the electric heater to the grill part.

The electric heater is mounted between the pair of reflection faces to be disposed in a middle region of the grill reflecting member.

The pair of reflection faces are disposed to slope downward to the electric heater.

The grill reflecting member further includes a supporting part supporting the electric heater in the middle region of the grill reflecting member.

The cooking apparatus further includes an oil collector disposed at a lower side of the grill reflecting member to collect oil therein, wherein the grill reflecting member includes an oil guiding hole guiding oil to the oil collector, provided in sides thereof with respect to of the supporting part.

### BRIEF DESCRIPTION OF THE DRAWINGS

These and other aspects and advantages of the present invention will become apparent and more readily appreciated from the following description of the embodiments, taken in conjunction with the accompany drawings of which:

FIG. 1 is an exploded perspective view illustrating a cooking apparatus according to an embodiment of the present invention;

FIG. 2 is an exploded perspective view illustrating a grill part and a grill housing of the cooking apparatus of FIG. 1;

FIG. 3 is a sectional view of the cooking apparatus taken along line III-III of FIG. 2 to illustrate the assembly of the grill part and the grill housing; and

FIG. 4 is a sectional view of the assembly of a grill part and a grill housing of a cooking apparatus according to another embodiment of the present invention

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below so as to explain the present invention by referring to the figures.

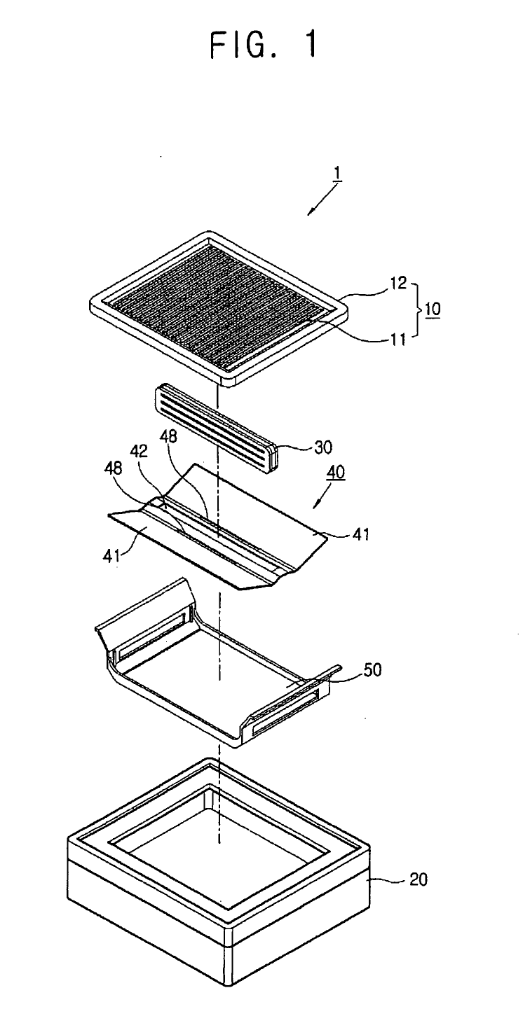

In FIG. 1, a cooking apparatus 1 according to an embodiment of the present invention comprising a grill part 10 on which food is cooked, and a grill housing 20 coupled with a lower part of the grill part 10, receiving therein a variety of parts and accessories.

The grill part 10 directly contacting and cooking food is coupled with an upper part of the grill housing 20. The grill part 10 comprises a plurality of grill bars 11 disposed at predetermined intervals so as to make food safely seated thereon, and a support frame 12 supporting the plurality of grill bars 11 along a circumferential direction thereof.

The grill housing 20 supports the lower part of the grill part 10 mounted on an upper side of an opening thereof, inside of which a heating space is formed. Inside the grill housing 20 are received a electric heater 30 formed therein as heating source, a grill reflecting member 40 reflecting heat from the electric heater 30, and an oil collector 50 collecting oil in a lower side of the grill reflecting member 40.

The electric heater 30 is mounted in a middle region of inside the grill housing 20 so that the electric heater 30 is disposed in a lower side of the grill part 10. End regions of the electric heater 30 respectively are supported by opposite side walls of the grill housing 20. Therefore, heat generated in the electric heater 30 is transmitted to the grill part 10 by the grill reflecting member 40.

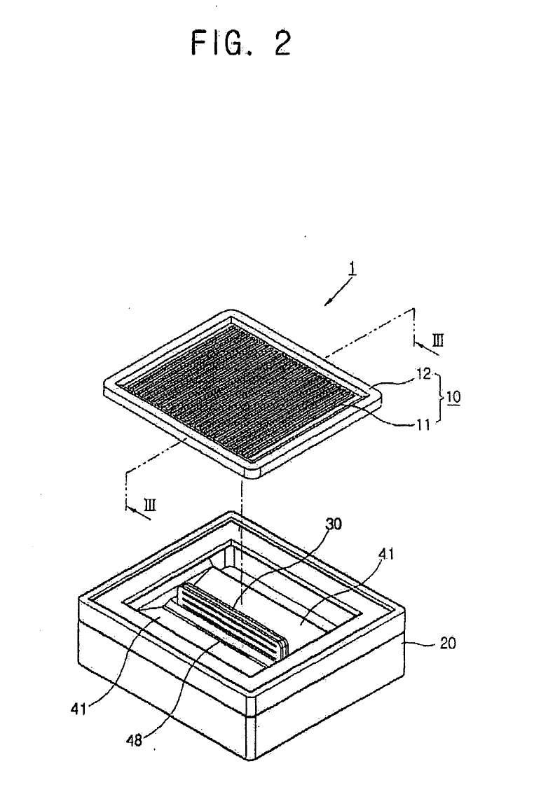

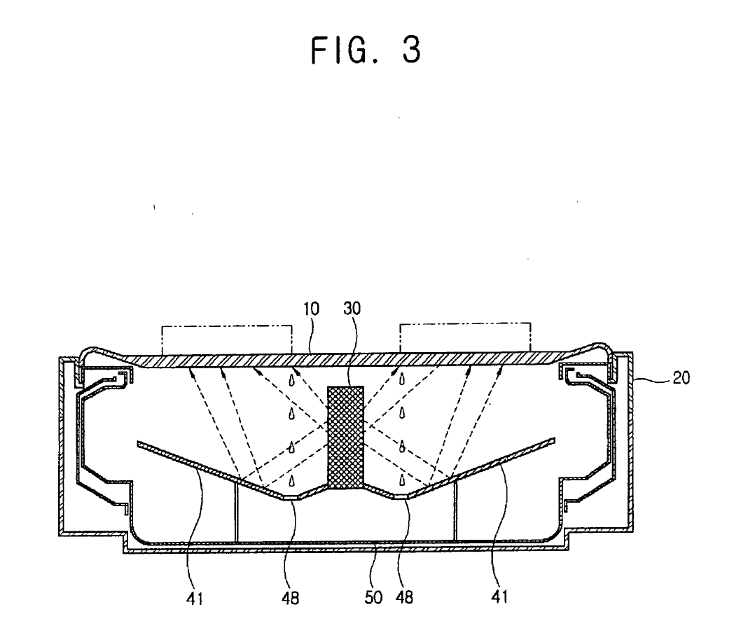

In FIGS. 2 and 3, the grill reflecting member 40 includes an approximately W-shaped section. The grill reflecting member 40 comprises metallic materials having an efficient thermal conductivity so as to reflect the heat generated from the electric heater 30 and then transmit it to the grill part 10.

The grill reflecting member 40 comprises a pair of reflection faces 41, and a supporting hole 42 used as a supporting part supporting a lower region of the electric heater 30 so that the electric heater 30 is disposed between the pair of the reflection faces 41. An oil guiding hole 48 guiding the oil or residues coming out of food being cooked to the oil collector 50 is provided on sides of the grill reflecting member 40 with respect to the supporting hole 42.

Alternatively, the supporting hole 42 may include a groove recessed in the reflection faces 41. As an alternative, a separate combine member (not shown) may be used to support the electric heater 30 on the grill reflecting member 40.

Therefore, the pair of reflection faces 41 are disposed in a direction of emitting heat from the electric heater 30, that is, on lateral sides with respect to the electric heater 30, to thereby reflect heat generated from the electric heater 30 to the grill part 10 in a bent manner.

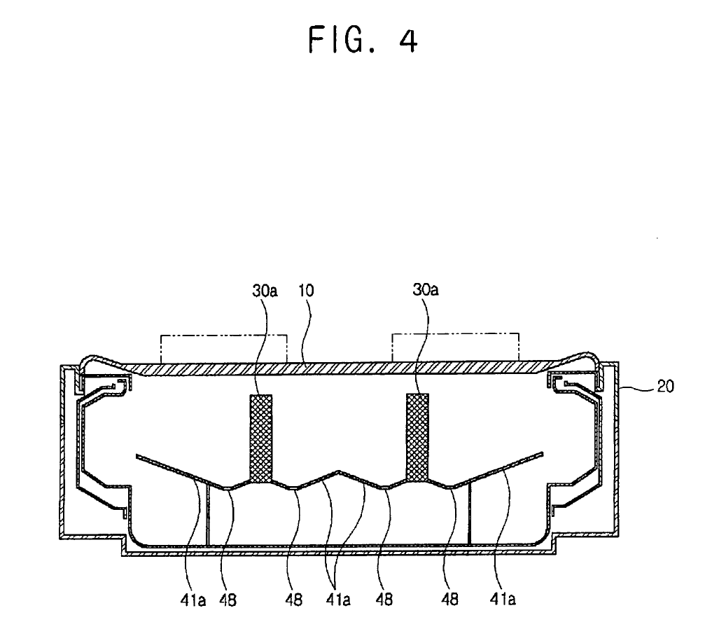

As described the above embodiment, one electric heater 30 is provided between the pair of reflection faces 41 so as to being disposed in the center of the grill housing 20. As an alternative, as illustrated in FIG. 4, the cooking apparatus may comprise pairs of reflection faces 41a, wherein each pair of reflection faces 41a comprises an electric heater 30a mounted thereon.

Hereinbelow, a cooking process of the cooking apparatus with this configuration will be described.

In FIGS. 3 and 4, since the oil collector 50 is disposed in a lower side of the grill reflecting member 40, the electric heaters 30, 30a are disposed in a middle region of an upper side of the grill reflecting member 40, and the grill part 10 is mounted in the upper part of the grill housing 20, when the electric heaters 30, 30a generate heat, food is cooked in the grill part 10 such that some of heat generated from the electric heaters 30, 30a is directly transmitted to the grill part 10, and the rest of heat generated from the electric heaters 30, 30a to be transmitted to the grill part 10 is reflected in the pair of reflection faces 41, 41a disposed on lateral sides with respect to the electric heaters 30, 30a. Oil coming out of food being cooked is guided to the oil collector 50 through the oil guiding hole 48 of the grill reflecting member 40.

As described above, in the cooking apparatus according to the present invention, the electric heaters 30, 30a are disposed between the pair of reflection faces 41, 41a in the middle region of the grill housing 20. Therefore, heat generated from the electric heaters 30, 30a is suppressed from being unnecessarily transmitted to the side walls of the grill housing 20 and then can be used when food is cooked in the grill part 10, thereby enhancing cooking efficiency.

As described above, the present invention provides a cooking apparatus enhancing a cooking efficiency so that heat generated from an electric heater is efficiently transmitted to food.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A cooking apparatus having a grill part to cook food thereon, and a grill housing coupled with the grill part, the cooking apparatus comprising:
an electric heater provided in a middle region of the grill housing to be disposed at a lower side of the grill part; and
a grill reflecting member reflecting heat generated from the electric heater to the grill part.

2. The cooking apparatus according to claim 1, wherein the grill reflecting member comprises at least a pair of reflection faces disposed in a direction of emitting the heat from the electric heater, to reflect the heat generated from the electric heater to the grill part.

3. The cooking apparatus according to claim 2, wherein the electric heater is mounted between the pair of reflection faces in a middle region of the grill reflecting member.

4. The cooking apparatus according to claim 3, wherein the pair of reflection faces are disposed to slope downward to the electric heater.

5. The cooking apparatus according to claim 4, wherein the grill reflecting member includes a supporting part supporting the electric heater in the middle region of the grill reflecting member.

6. The cooking apparatus according to claim 5, further comprising an oil collector disposed at a lower side of the grill reflecting member to colleting oil,
wherein the grill reflecting member comprises an oil guiding hole guiding oil to the oil collector, disposed in sides with respect to of the supporting part.

7. The cooking apparatus of claim 1, wherein the grill reflecting member comprises a W-shaped section.

8. The cooking apparatus of claim 4, wherein the supporting part comprises a groove recessed in the pair of reflection faces.

9. The cooking apparatus of claim 2, wherein the pair of reflection faces are disposed such that the electric heater is mounted between each reflection face, to thereby reflect heat generated from the electric heater to the grill part in a bent manner.

10. A cooking apparatus having a grill part to cook food thereon, and a grill housing coupled with the grill part, the cooking apparatus comprising:
a pair of electric heaters disposed at a lower side of the grill part, in a middle region of the grill housing to generate heat for cooking food;
a grill reflecting member reflecting heat generated from the electric heaters to the grill part,
wherein a portion of the heat generated by the electric heaters is directly transmitted to the grill part, and a remaining portion of the generated heat is reflecting by the grill reflecting member and then transmitted to the grill part.

11. The cooking apparatus of claim 10, wherein the grill reflecting member comprises pairs of reflection faces, wherein each electric heater is mounted between each pair of reflection faces.
